(19) United States
(12) Patent Application Publication
(10) Pub. No.: US 2013/0159334 A1
(43) Pub. Date: Jun. 20, 2013

(54) METHOD FOR IDENTIFYING AND EXTRACTING UNDESIRABLE ACTIVITIES OF MOTORISTS FROM DMV AND INSURANCE CARRIER DATA STREAMS

(71) Applicants: Richard Buono, Brightwaters, NY (US); Kevin McAllister, New York, NY (US)

(72) Inventors: Richard Buono, Brightwaters, NY (US); Kevin McAllister, New York, NY (US)

(21) Appl. No.: 13/713,722

(22) Filed: Dec. 13, 2012

Related U.S. Application Data
(60) Provisional application No. 61/630,560, filed on Dec. 14, 2011.

(51) Int. Cl. G06F 17/30

(52) U.S. Cl. CPC G06F 17/30386
USPC 707/758

(57) ABSTRACT

A method (10) that identifies automobile insurance policy risks by comparing automobile insurance policy records (12) with driving violation records (14).

### CROSS-REFERENCE TO RELATED APPLICATIONS

This application claims the benefit of Provisional U.S. Patent Application Ser. No. 61/630560 entitled, “A Method for Identify, Extract and Display Undesirable Activities of Motorists from DMV and Insurance Carrier Data Streams”, filed in the name of Richard Buono and Kevin McAllister, on Dec. 14, 2011, the disclosure of which is also hereby incorporated herein by reference.

### FIELD OF INVENTION

The present invention generally relates to risk analysis. More particularly, the present invention relates to a system and method of identifying motor vehicle owners that demonstrate potentially undesirable driving activities.

### BACKGROUND OF THE INVENTION

Motor vehicle insurance providers commonly monitor the risk presented by a particular insurance policy holder by retrieving records of moving traffic violations, related to the drivers specifically listed as vehicle operators under the insurance policy, from various state and municipal Department of Motor Vehicle (DMV) databases. Such violations are risk factors because they are indicative of either a lack of skill or prudence on the part of the vehicle driver while operating the insured vehicle (such as an automobile, motorcycle, etc.). The motor vehicle insurance providers consequently apply a measure of risk posed by the violations. The risk analysis results in an adjustment to the risk presented by the policy holder and, more importantly, in an adjustment to the insurance premiums that reflect the newly-measured risk and that are required to be paid by the policy holder. In most cases, the uncovered moving traffic violations will cause the insurance premiums to increase. In some cases, the uncovered moving traffic violations may indicate a relatively high measure of risk that is unacceptable to an insurance provider and the insurance provider cancels the policy altogether.

Although motor vehicle insurance providers have a mechanism to monitor when a specifically listed vehicle operator under an insurance policy is issued a moving traffic violation, there currently is no mechanism to permit monitoring of vehicle drivers who are not specifically listed under the respective policy when they are issued a moving traffic violation. The violations of these unlisted drivers are also risk factors but adjustments to the risk presented by a particular insurance holder cannot be measured since the violations typically remain undiscovered. Moreover, the adjustments to the insurance premiums that would reflect and compensate for the newly-measured risk become uncollected by the respective insurance provider. Ultimately, this undiscovered information distorts the risk analyses for all policy holders, i.e., the risk pool, and insurance premiums are improperly distributed among them.

### SUMMARY OF THE INVENTION

An embodiment of the present invention obviates the above problems by providing a method of identifying motor vehicle owners that demonstrate activities posing a motor vehicle insurance policy risk, comprising selecting or drawing a first record from a first data repository; comparing the first record from the first data repository to the records of a second data repository, each of said records of the first data repository and the second data repository having a plurality of data elements; selecting the criteria to determine how the data elements of said records are to be compared; specifying particular data elements of said records to be compared and identifying any instance of the first record and a record of the second data repository having specified data elements that match; and selecting a key data element of said records and identifying any instance of matching records having respective selected key data elements that are not matching. The records of the first data repository may comprise data from motor vehicle insurance policies and the records of the second data repository may comprise data from records of moving traffic violations. The comparing step may comprise comparing the data elements of the first record with the corresponding data elements of each record of the second data repository.

The specifying and identifying step may comprise identifying any instance of the first record and a record of the second data repository having a desired number of specified data elements that match. Also, the specifying and identifying step may comprise specifying a license plate number of an owner's vehicle as the particular data element. In such case, the specifying and identifying step may comprise specifying the license plate number of an owner's vehicle as the particular data element and the selecting and identifying step may comprise selecting driver's license number as the key data element. The specifying and identifying step may also comprise distinguishing any instance of the first record and a record of the second data repository having specified data elements that are not matching on the basis of a missing data element from one of the records. The specifying and identifying step may also comprise distinguishing any instance of the first record and a record of the second data repository having specified data elements that are not matching on the basis of a data element from one of the records having transposed characters.

The method may further comprise repeating the steps for subsequently selected or drawn records from the first data repository. Also, the method may further comprise issuing an alert or report upon identifying any instance of matching records having respective selected key data elements that are not matching. Also, the method may further comprise compiling identified instances of matching records having respective selected key data elements that are not matching for subsequent retrieval and usage. Also, the method may further comprise reporting identified instances of matching records having respective selected key data elements that are not matching using selected criteria related to the data elements of the matching records or the instances identified by the specifying and identifying and selecting and identifying steps.

An embodiment of the present invention may also provide a method of identifying motor vehicle insurance policy risks, comprising selecting or drawing a system record from a first data source; comparing the drawn system record of the first data source to system records of a second data source, each system record having a plurality of data elements; selecting criteria to determine how the data elements of the respective system records are to be compared; and identifying any instance of the respective system records being compared having a selected combination of matching and non-matching data elements. The selecting step may comprise specifying particular data elements to be compared. In such case, the specifying step may comprise specifying a license plate number of a motor vehicle and a license identification number of a driver as the specified particular data elements and the selecting step may comprise selecting the motor vehicle license plate numbers of the respective system records to be matching data elements and the driver's license identification numbers of the respective system records to be non-matching elements. Alternatively, the specifying step may comprise specifying a license plate number of a motor vehicle, a state of registration of a motor vehicle, and a location of a scan of the license plate number of a motor vehicle as the specified particular data elements, and the selecting step may comprise selecting the motor vehicle license plate numbers of the respective system records to be matching data elements and selecting the state of registration of a motor vehicle of a respective system record and the location of a scan of the license plate number of an motor vehicle of the other respective system record to be non-matching elements.

The identifying step may comprise distinguishing any instance of the drawn system record and a system record of the second data source having specified data elements that are not matching on the basis of a missing data element from one of the records or on the basis of a data element from one of the records having transposed characters. The method may further comprise repeating the steps for subsequently selected or drawn system records from the first data source. Also, the method may further comprise issuing an alert or report upon identifying any instance of the respective system records being compared having a selected combination of matching and non-matching data elements. Also, the method may further comprise compiling compared system records identified to have a selected combination of matching and non-matching elements for subsequent retrieval and usage.

An embodiment of the present invention may also provide a system of identifying motor vehicle insurance policy risks, comprising means for selecting a system record having a plurality of data elements from a first data source; means for comparing the selected system record of the first data source to system records of a second data source, each system record of the second data source having a plurality of data elements; and means for selecting criteria to compare the data elements of the respective system records; said means for comparing flagging the respective system records being compared having a selected combination of matching and non-matching data elements.

### BRIEF DESCRIPTION OF THE DRAWINGS

For a better understanding of the present invention, reference is made to the following description of an exemplary embodiment thereof, and to the accompanying drawings, wherein:

FIG. 1 is an illustration of a system that is constructed in accordance with an embodiment of the present invention; and

FIG. 2 is a block diagram of a method implemented in accordance with an embodiment of the present invention.

### DETAILED DESCRIPTION

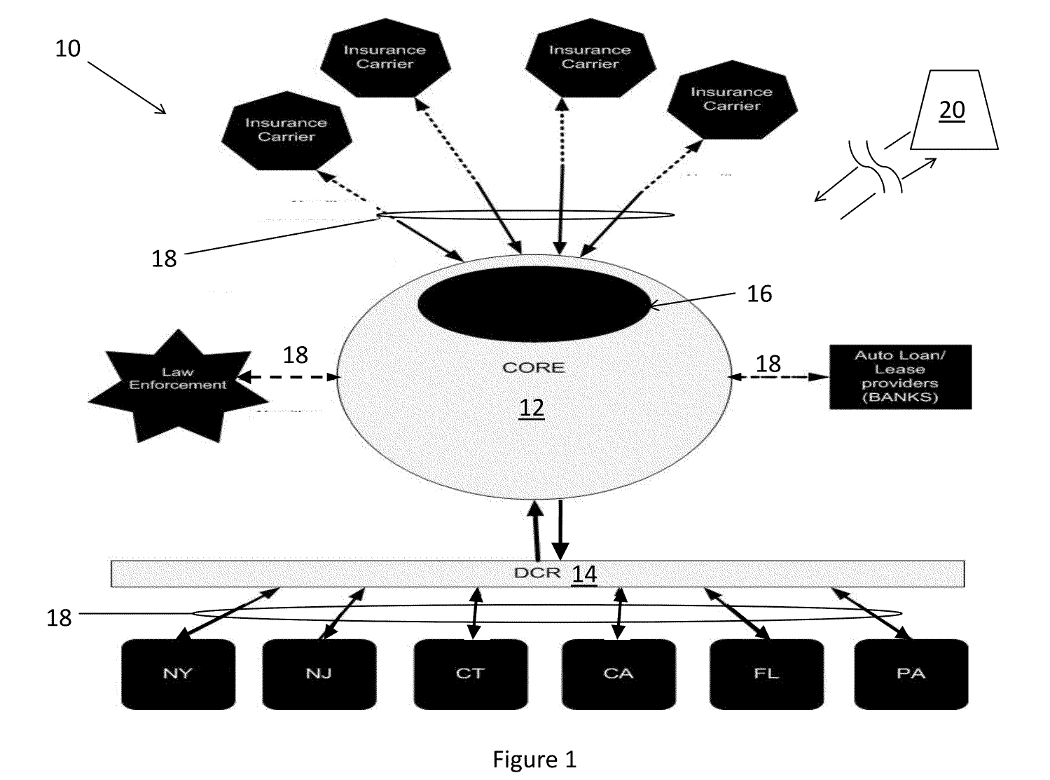

FIG. 1 is an illustration of a system 10 that is constructed in accordance with an embodiment of the present invention. The system 10 comprises a first or central data repository 12 (also known as CORE, which is an acronym for Central Operative Repository Engine) that stores data from motor vehicle insurance policies obtained from disparate motor vehicle insurance providers/carriers. The system 10 also comprises a secondary data repository 14 (also known as DCR, which is an acronym for Driving, Conviction, Record) that stores data from records of moving traffic violations issued by governmental authorities. The violation records may be obtained from any number or types of record sources of moving traffic violations, for example, governmental Departments of Motor Vehicles (DMVs); other governmental departments, agencies and entities; private sector sources; etc. Note that the figure illustrates that the violation records may originate from a number of geopolitical areas (i.e., the states of NY, NJ, CT, CA, FL and PA) since the record sources are typically organized with respect to the originating geopolitical areas. However, the system 10 is capable of either including or excluding record sources, regardless of originating location, as desired. The depositories 12, 14 may be adapted to communicate with one another.

The central data repository 12 and the secondary data repository 14 extract the same data elements from each respective source data record (i.e., insurance policy and violation record). Each repository 12, 14 then uses the extracted data elements to form a new system 10 record for each insurance policy (CORE record) and a new system 10 record for each violation record (DCR record), respectively. All the new system 10 records are formatted in a common manner to facilitate the searching of data elements between system 10 records of the two record groups. The repositories 12, 14 may be adapted either to access and store the source data records and then extract the selected data elements from the records or to scan the source data records in the respective record source and then extract the selected data elements from the source data records. Also, the repositories 12, 14 may be adapted to acquire the selected data elements either by first aggregating the source data records, or the selected data, from the insurance providers/carriers and the record sources of moving traffic violations or by real-time reading of the source data records, or selected data, or a combination of the two methods. The selected data may comprise data elements that can identify the insured vehicle, the driver of the insured vehicle, the insurance policy; and the insurance policy holder. Examples of the data elements are the license plate number of the insured vehicle, driver's license identification number, insurance policy number, and insurance policy holder identification number.

The system 10 also comprises a processor 16 that operates the system 10 and its components by accessing and implementing operating system and application software programs that may be stored in the processor 16, in one of the repositories 12, 14, or in a separate, accessible storage medium (not shown) for the system 10. The processor 16 also specifically implements an application software having an algorithm or method to search the new system 10 records in both the central data repository 12 and the secondary data repository 14 according to defined criteria and to identify specific relationships between the two record groups. The system 10 also comprises a telecommunications or networking interface 18 that enables the system 10 to communicate with external systems or parties, for example, the insurance providers, record sources of moving traffic violations, financial institutions, law enforcement agencies, etc. The interface 18 specifically enables the central data repository 12 and the secondary data repository 14 to interact with the insurance providers/carriers and record sources of moving traffic violations either on a batch and/or real-time basis (as noted above). The interface 18 may employ wired or wireless technologies, or a combination, and employ appropriate security/privacy mechanisms. The system 10 also comprises a user interface 20 that permits a system 10 user to control and monitor the operation of the system 10 and the other system 10 components.

The system 10 components may be operably connected to one another by conventional networking or telecommunications means, wired and/or wireless. The system 10 components, or any subset, may or may not be located in the same location. Accordingly, although FIG. 1 illustrates the processor 16 being positioned within the central data repository 12, the processor 16 may be physically located apart from the central data repository 12.

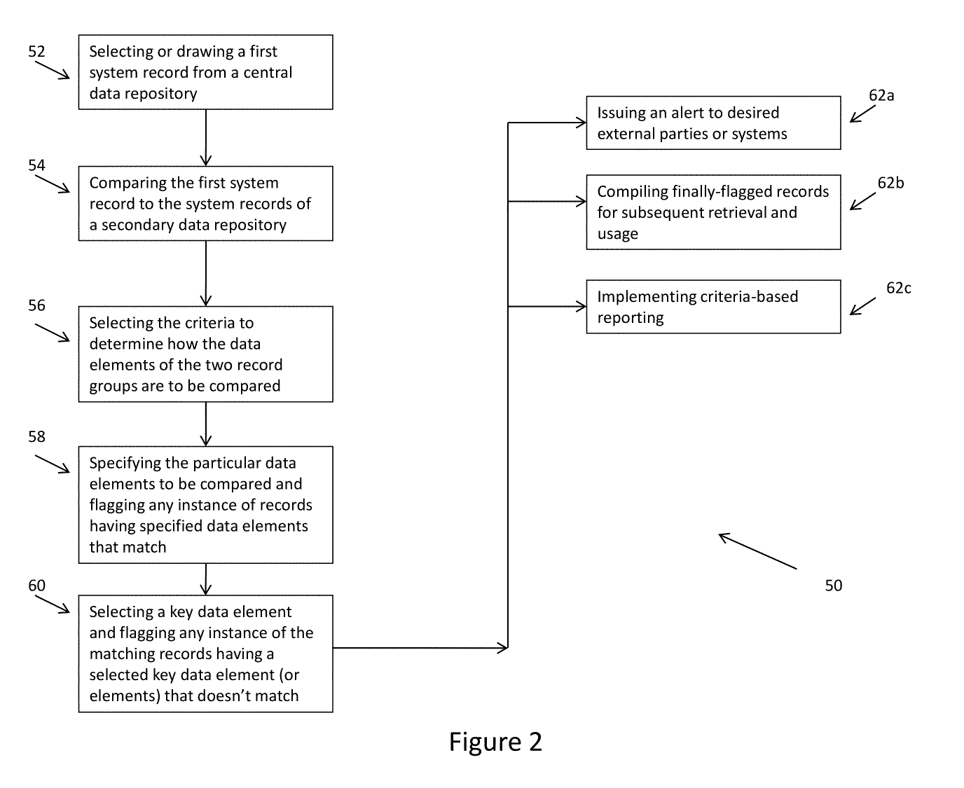

FIG. 2 is a block diagram of a method 50 implemented by the processor 16 to search the new system 10 records in both the central data repository 12 and the secondary data repository 14 and analyze the two record groups. The method 50 comprises selecting or drawing a first new system record from the central data repository 12 (Step 52) and comparing the first new system record to the new system records of the secondary data repository 14 (Step 54). More specifically, the data elements of the first new system record are compared with the corresponding data elements of each new system record of the secondary data repository 14. The system 10 user selects the criteria to determine how the data elements of the two record groups are to be compared (Step 56). Generally, the user specifies the particular data element (or elements) of the first new system record to be compared and the system 10 searches the secondary data repository 14 and identifies (flags) any instance of records having specified data elements that match (Step 58), e.g., license plate number of the insured vehicle, or license plate number of insured vehicle and insurance policy number. Alternatively, the system 10 may flag any instance of records having a desired number of specified data elements that match. The user also selects a key data element (or elements) and the system 10 further identifies or flags in a second manner any instance of the matching records having a selected key data element (or elements) that doesn't match (Step 60). So, for example, the system 10 user may specify the license plate number of the insured vehicle be compared between the two record groups and select the driver's license number as the key data element. A system 10 search would then obtain a list of DCR records “matching” the drawn CORE record (i.e., matching the selected data element(s) of the drawn CORE record). The system 10 then searches the matching list of DCR records using the key data element and, in the case where the drawn CORE record and a DCR record have matching license plate numbers but different driver's license numbers, the system 10 would flag in a second manner the two records (the two records being considered “finally-flagged”). The method 50 is then repeated for subsequently selected or drawn new system 10 records from the central data repository 12. This may be accomplished in a number of ways, such as, automatically or via selection by the system 10 user.

As an alternative, the user specifies particular data elements to be compared and the system 10 searches the secondary data repository 14 and identifies (flags) any instance of records having a selected combination of matching and non-matching specified data elements. So, for example, the system 10 user may specify the license plate number of the insured vehicle and a driver's license identification number be compared between the two record groups and select the license plate numbers to match and the driver's license numbers to not match. A system 10 search would then obtain a listing of DCR records have matching license plate numbers of the drawn CORE record but different driver's license numbers and the system 10 would flag the two records (the two records being considered “finally-flagged”).

The system 10 may be adapted to distinguish between data elements between two records that don't match and a missing data element from one of the records. In this way, the system 10 may flag those two records apart and differently than the other flagged records for subsequent retrieval and treatment by the user. Similarly, the system 10 may also be adapted to identify data elements having unintentionally transposed characters, or other character errors, that distort the results of the comparison and identification steps of the method 50. The system 10 may flag those two records apart and differently than the other flagged records for subsequent retrieval and treatment by the user. Note that flagging two respective records includes the system 10 associating the two records to enable subsequent retrieval and usage of both records.

Upon identifying two finally-flagged records (i.e., a CORE/DCR pair), the system 10 may issue an alert or report, or other documentation (electronic or physical), via the network interface 18 to desired external parties or systems (Step 62a). The primary external parties or systems are likely to be the insurance providers that have a strong interest in information that may present a policy risk, as noted above; and financial institutions that are the actual owners or loan holders of the insured vehicles and have a strong interest in information that may present a risk to the vehicle as a collateral asset. Accordingly, the system 10 may issue an alert or other documentation in any desired format to accommodate the end user. As an alternative, or as an addition to issuing an alert or report, the system 10 may compile finally-flagged records for subsequent retrieval and usage, such as issuing alerts in batches, performing further data analyses, creating reports and other documentation, etc. (Step 62b).

Whether via compiling or not, the system 10 may be adapted to implement a criteria-based reporting for the external parties or systems and the system 10 user (Step 62c). The type of reporting would be triggered depending upon desired criteria. So, for example, if the desired reporting criteria relates to a threshold number of finally-flagged records (i.e., a CORE/DCR pair) and fewer than the threshold number are uncovered, the system 10 may only issue a low priority insurance policy review alert to the insurance provider. But, if fewer than the threshold number of finally-flagged records are uncovered and the age of the driver of the insured vehicle (which can be an extracted data element) is less than twenty years of age, the desired criteria (i.e., teenage drivers) may indicate that a more urgent alert (signifying a greater policy risk) can be issued to the insurance provider.

Other modifications are possible within the scope of the invention. For example, the system 10 may utilize data in the second data repository 14 from other record sources that provide information that may present a policy risk, such as vehicle parking violations, credit scores of the policy holder, criminal records of the policy holder, etc. This may used be instead of or as a supplement to the record sources of moving traffic violations described above. Also, either repository 12, 14 or both may extract additional data elements from the respective source records that have no counterpart in the other repository source record (e.g., the specific moving traffic violation, or associated code). The system 10 may utilize the additional non-common data element, for example, as a key data element, reporting criterion, or a weighting factor for another data element, source record, flagged records, etc.

Also, although the steps of the method 50 have been described in a specific sequence, the order of the steps may be re-ordered in part or in whole and the steps may be modified, supplemented, or omitted as appropriate. Also, the method 50 may use various well known algorithms and software applications to implement the steps and substeps. Further, the method 50 may be implemented in a variety of algorithms and software applications. Further, the method 50 may be supplemented by additional steps or techniques. It is also understood that the method 50 may carry out all or any of the steps using real-time data, stored data, data from a remote computer network, or a mix of data sources. For example, the method 50 can be used to try to determine when an insurance policy holder has registered a vehicle in one state or geographical area but lives in a different state or geographical area (which may present a differently-measured insurance risk). This can be accomplished, as described above, by comparing the insurance policy data (which typically has the registration state) with violation data (which may or may not have current address information). Alternatively, the method 50 can utilize additional data from an external source, such as a license plate reader that can be used to occasionally scan the respective vehicle's license plate (either at violation locations, repair facilities, state inspection facilities, or other insurance company-prescribed or random locations). The method 50 can then be used to flag the occurrence, or flag a threshold number of occurrences or a threshold number of occurrences over a certain period of time, of the vehicle being in a location not within the registered state.

Also, the various components of the system 10 are conventional and well known components. They may be configured and interconnected in various ways as necessary or as desired. Further, although in the described method 50 the user may use self-contained instrumentation, the user may use other instrumentation in combination with or in place of the instrumentation described for any step or all the steps of the method 50, including those that may be made available via telecommunication means. Further, the described method 50, or any steps, may be carried out automatically by appropriate instrumentation or with some manual intervention.

What is claimed is:

1. A method of identifying motor vehicle owners that demonstrate activities posing a motor vehicle insurance policy risk, comprising selecting or drawing a first record from a first data repository; comparing the first record from the first data repository to the records of a second data repository, each of said records of the first data repository and the second data repository having a plurality of data elements; selecting the criteria to determine how the data elements of said records are to be compared; specifying particular data elements of said records to be compared and identifying any instance of the first record and a record of the second data repository having specified data elements that match; and selecting a key data element of said records and identifying any instance of matching records having respective selected key data elements that are not matching.

2. The method of claim 1, wherein the records of the first data repository comprise data from motor vehicle insurance policies and the records of the second data repository comprise data from records of moving traffic violations.

3. The method of claim 1, wherein the comparing step comprises comparing the data elements of the first record with the corresponding data elements of each record of the second data repository.

4. The method of claim 1, wherein the specifying and identifying step comprises identifying any instance of the first record and a record of the second data repository having a desired number of specified data elements that match.

5. The method of claim 1, wherein the specifying and identifying step comprises specifying a license plate number of an owner's vehicle as the particular data element.

6. The method of claim 5, wherein the specifying and identifying step comprises specifying the license plate number of an owner's vehicle as the particular data element and the selecting and identifying step comprises selecting driver's license number as the key data element.

7. The method of claim 1, wherein the specifying and identifying step comprises distinguishing any instance of the first record and a record of the second data repository having specified data elements that are not matching on the basis of a missing data element from one of the records.

8. The method of claim 1, wherein the specifying and identifying step comprises distinguishing any instance of the first record and a record of the second data repository having specified data elements that are not matching on the basis of a data element from one of the records having transposed characters.

9. The method of claim 1, further comprising repeating the steps for subsequently selected or drawn records from the first data repository.

10. The method of claim 1, further comprising issuing an alert or report upon identifying any instance of matching records having respective selected key data elements that are not matching.

11. The method of claim 1, further comprising compiling identified instances of matching records having respective selected key data elements that are not matching for subsequent retrieval and usage.

12. The method of claim 1, further comprising reporting identified instances of matching records having respective selected key data elements that are not matching using selected criteria related to the data elements of the matching records or the instances identified by the specifying and identifying and selecting and identifying steps.

13. A method of identifying motor vehicle insurance policy risks, comprising:
a. selecting or drawing a system record from a first data source;
b. comparing the drawn system record of the first data source to system records of a second data source, each system record having a plurality of data elements;
c. selecting criteria to determine how the data elements of the respective system records are to be compared; and
d. identifying any instance of the respective system records being compared having a selected combination of matching and non-matching data elements.

14. The method of claim 13, wherein the selecting step comprises specifying particular data elements to be compared.

15. The method of claim 14, wherein the specifying step comprises specifying a license plate number of a motor vehicle and a license identification number of a driver as the specified particular data elements and the selecting step comprises selecting the motor vehicle license plate numbers of the respective system records to be matching data elements and the driver's license identification numbers of the respective system records to be non-matching elements.

16. The method of claim 14, wherein the specifying step comprises specifying a license plate number of a motor vehicle, a state of registration of a motor vehicle, and a location of a scan of the license plate number of a motor vehicle as the specified particular data elements, and the selecting step comprises selecting the motor vehicle license plate numbers of the respective system records to be matching data elements and selecting the state of registration of a motor vehicle of a respective system record and the location of a scan of the license plate number of an motor vehicle of the other respective system record to be non-matching elements.

17. The method of claim 13, wherein the identifying step comprises distinguishing any instance of the drawn system record and a system record of the second data source having specified data elements that are not matching on the basis of a missing data element from one of the records or on the basis of a data element from one of the records having transposed characters.

18. The method of claim 13, further comprising repeating the steps for subsequently selected or drawn system records from the first data source.

19. The method of claim 13, further comprising issuing an alert or report upon identifying any instance of the respective system records being compared having a selected combination of matching and non-matching data elements

20. The method of claim 13, further comprising compiling compared system records identified to have a selected combination of matching and non-matching elements for subsequent retrieval and usage.

21. A system of identifying motor vehicle insurance policy risks, comprising:
a. means for selecting a system record having a plurality of data elements from a first data source;
b. means for comparing the selected system record of the first data source to system records of a second data source, each system record of the second data source having a plurality of data elements; and
c. means for selecting criteria to compare the data elements of the respective system records; said means for comparing flagging the respective system records being compared having a selected combination of matching and non-matching data elements.
